(19) United States
(12) Patent Application Publication
(10) Pub. No.: US 2019/0183124 A1
(43) Pub. Date: Jun. 20, 2019

(54) METHOD FOR CONTROLLING PESTS IN MODIFIED PLANTS

(71) Applicant: BASF SE, Ludwigshafen am Rhein (DE)

(72) Inventors: Sebastian SOERGEL, Limburgerhof (DE); Birgit GOCKEL, Ludwigshafen (DE); Hector Alejandro AREVALO, Research Triangle Park, NC (US); Matthias POHLMAN, Research Triangle Park, NC (US)

(21) Appl. No.: 16/328,060

(22) PCT Filed: Aug. 22, 2017
(86) PCT No.: PCT/EP2017/071103

§ 371 Date: Feb. 25, 2019

(30) Foreign Application Priority Data
Aug. 30, 2016 (EP) 16186194.3
Sep. 6, 2016 (EP) 16187320.3

(51) Int. Cl. A01N 43/58

(52) U.S. Cl. CPC A01N 43/58

(57) ABSTRACT

A method for controlling pests of modified plants, particularly soybean plants, comprising the step of contacting the plant, parts of it, its propagation material, the pests, their food supply, habitat or breeding grounds with one or more compounds of formula I

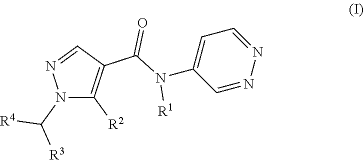

wherein the variables are as defined in the specification.

The invention relates to methods of pest control by pyrazole compounds of formula I,

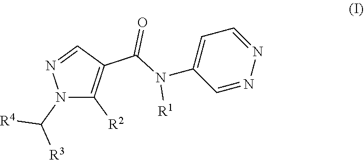

wherein
R¹ is H, CH₃, or C₂H₅;
R² is CH₃,
R³ is CH₃, CH(CH₃)₂, CF₃, CHFCH₃, or 1-CN-c-C₃H₄;
R⁴ is CH₃; or
R³ and R⁴ may together form CH₂CH₂CF₂CH₂CH₂.

Faboideae, such as soybeans (Glycine max) are important commercial crops.

Soybeans are considered to be a source of complete protein (Henkel, J., 2000, “Soy: Health Claims for Soy Protein, Question About Other Components”. FDA Consumer (Food and Drug Administration 34 (3): 18-20). For this reason, soy is a good source of protein. According to the US Food and Drug Administration, soy protein products can be good substitutes for animal products because soy offers a ‘complete’ protein profile. Soy protein products can replace animal-based foods which also have complete proteins but tend to contain more fat, especially saturated fat without requiring major adjustments elsewhere in the diet.

Soybean protein isolate is highly valuable as it has a biological value of 74 (Protein Quality Evaluation: Report of the Joint FAO/WHO Expert Consultation. Bethesda, Md. (USA): Food and Agriculture Organization of the United Nations (Food and Nutrition Paper No. 51). December 1989).

In agriculture soybeans can produce at least twice as much protein per acre than some other major vegetable or grain crop, e.g. 5 to 10 times more protein per acre than land set aside for grazing animals to make milk, and up to 15 times more protein per acre than land set aside for meat production (“Soy Benefits”, National Soybean Research Laboratory, February 2012).

Thus, soybeans can be regarded as a globally important crop providing oil and protein.

Nevertheless, soybean plants are vulnerable to a wide range of bacterial diseases, fungal diseases, viral diseases and parasites. Soybeans are considered to be e.g. the second-most valuable agricultural export in the United States behind corn.

Consequently, in view of the importance of soybean in agriculture, proper pest management is required in order not to jeopardize yield and quality of the soybean crops.

Stink bugs (order of Hemiptera, family of Pentatomidae) are animal pests and true bugs. They are probably one of the most common pest problems in soybean (Stewart et al., Soybean Insects —Stink bugs, University of Tennessee Institute of Agriculture, W200 09-0098).

Stink bugs feed on over 52 plants, including native and ornamental trees, shrubs, vines, weeds, and many cultivated crops such as corn and cotton, as well as numerous uncultivated plants, and their preferred hosts are nearly all wild plants. They build up on these hosts and move to soybeans late in the season as their preferred foods mature.

Stink bugs may feed on many parts of the plant; however, they typically target developing seed including the pods, meaning that injury to soybean seed is the primary problem associated with stink bug infestations.

Brown or blackish spots may occur where their mouthparts penetrate the plant tissue, but little external signs of feeding injury may be present. Feeding may cause deformation, shriveling or abortion of small seed. Larger seed may only be partly discolored by feeding injury, but this can affect seed quality. High levels of seed abortion may cause the “green bean effect” where foliage is retained and plant maturity is delayed (Stewart et al., Soybean Insects—Stink bugs, University of Tennessee Institute of Agriculture, W200 09-0098).

Stink bugs inflict mechanical injury to the seed as well as transmitting the yeast-spot disease organism. The degree of damage caused by this pest depends to some extent on the developmental stage of the seed when it is pierced by the stink bug's needlelike mouthparts. The younger the seed when damaged, the greater the yield reduction. Although late season infestations may not affect yield, bean oil content and germination will be reduced.

In certain regions the green stink bug (Acrosternum hilare) is one of the most common species that feeds on soybean. The brown stink bug (Euschistus servus) is another common component of the stink bug complex.

Of the complex of sucking bugs that occur in cultivation, the brown stinkbug Euschistus heros is currently considered to be the most abundant species in northern Parana to Central Brazil (Correa- Ferreira & Panizzi, 1999), and is a significant problem in soybean (Schmidt et al., 2003). The bugs occur in soybeans from the vegetative stage and are harmful from the beginning of pod formation until grain maturity. They cause damage to the seed (Galileo & Heinrichs 1978, Panizzi & Slansky Jr., 15, 1985) and can also open the way to fungal diseases and cause physiological disorders, such as soybean leaf retention (Galileo & Heinrichs 1978, Todd & Herzog, 1980).

Other plant feeding species that may be present include the red-shouldered stink bug (Thyanta custator) and the dusky-brown stink bug (Euschistus tristigmus). Another species, the southern green stink bug (Nezara vindula), is often confined to the southernmost counties of the US.

Predatory (beneficial) stink bugs such as the spined soldier bug (Podisus maculaventris) may also be found in soybean and are sometimes mistaken for brown or dusky-brown stink bugs.

Control of stinkbugs in soybean is often vital to prevent significant economic damage.

Insecticides commonly used to control stinkbugs include pyrethroids, neonicotinoids and organophosphates, though pyrethroid insecticides are usually the method of choice for controlling stink bugs in soybean. However, there are increasing problems with insecticide resistance, particularly in brown stink bug populations and particularly to pyrethroids. Euschistus heros can also be difficult to manage using organophosphates or endosulfan (Sosa-Gomez et al., 2009). There is therefore a need for effective ecological methods of controlling stinkbugs in soybean.

Particularly insecticides acting on the gamma-aminobutyric acid (GABA)-gated chloride channel (disclosed in e.g. EP 1 731 512, WO 2009/002809, and WO 2009/080250) seem to be effective for controlling stinkbugs, especially in soybean such as described in WO2012/104331.

It has now been found that the pyrazole compounds of formula I as defined in the outset provide an efficient control against pests on Faboideae, in particular soybeans, especially against pests from the families of Pentatomidae, Cicadellidae, Aleyrodidae, and Aphididae, in particular from the families of Aleyrodidae, Aphididae, and Pentatomidae.

These compounds therefore represent an important solution for controlling pests of Faboideae, in particular soybeans, in particular pests from the family of pentatomidae, stink bugs, and thereby safeguarding plants, crops and propagation material from the infestation by such pests, particularly where the pests are resistant to current methods.

The pyrazole compounds of formula I and their insecticidal activity are known from WO2012/143317, and WO2015/055497. However, none of these documents discloses an acceptable efficacy of such active compounds against typical pests of modified Faboideae, preferably soybeans, in particular stink bugs, whiteflies, leafhoppers, and aphids on GMO plants. As stated above, these pests are difficult to control with typical soybean pesticides.

Accordingly, in one aspect of the invention there is provided a method for controlling pests of Faboideae, in particular soybean plants, comprising the step of contacting the Faboideae, in particular soybean, plant, parts of it, its propagation material, the pests, their food supply, habitat or breeding grounds with one or more compounds of formula I.

In a further aspect of the invention there is provided the use of one or more compounds of formula I for controlling pests in Faboideae, in particular soybean crops.

A further aspect of the invention relates to a method for controlling pests from the family of Pentatomidae and/or Cicadellidae and/or Aleyrodidae and/or Aphididae, comprising the step of contacting the pests, their food supply habitat and/or breeding ground with one or more compounds of formula I, which are particularly selected from compounds I-1 to I-3:

1-(1,2-dimethylpropyl)-N-ethyl-5-methyl-N-pyridazin-4-yl-pyrazole-4-carboxamide (I-1), 1-[1-(1-cyanocyclopropyl)ethyl]-N-ethyl-5-methyl-N-pyridazin-4-yl-pyrazole-4-carboxamide (I-2), and N-ethyl-1-(2-fluoro-1-methyl-propyl)-5-methyl-N-pyridazin-4-yl-pyrazole-4-carboxamide (I-3).

One aspect of the invention relates to the use of one or more compounds of formula I for controlling pests from the family of Pentatomidae.

A further aspect of the invention relates to the use of one or more compounds of formula I for controlling pests from the family of Cicadellidae.

A further aspect of the invention relates to the use of one or more compounds of formula I for controlling pests from the family of Aphididae.

The methods and uses of the invention are for controlling and/or preventing infestation of Faboideae plants, Faboideae crops and Faboideae propagation material by pests. In one preferred embodiment, the Faboideae plants, crops or propagation material are soybean plants, crops or propagation material. In general the pests are from the family of Pentatomidae and/or Aleyrodidae and/or Aphididae.

Preferably the methods and uses of the present invention are applied against pests from the family of Pentatomidae, stink bugs. More preferably against stink bugs that are resistant to other insecticides, e.g. pyrethroid insecticides. Stinkbugs that are “resistant” to a particular insecticide refers e.g. to strains of stinkbugs that are less sensitive to that insecticide compared to the expected sensitivity of the same species of stinkbug. The expected sensitivity can be measured using e.g. a strain that has not previously been exposed to the insecticide.

In another embodiment the methods and uses of the present invention are applied against pests from the family of Aleyrodidae, whiteflies. More preferably against whiteflies that are resistant to other insecticides, e.g. pyrethroid insecticides. Such resistant whiteflies are particularly Bemisia tabaci biotypes. Whiteflies that are “resistant” to a particular insecticide refers e.g. to strains of whiteflies that are less sensitive to that insecticide compared to the expected sensitivity of the same species of whiteflies. The expected sensitivity can be measured using e.g. a strain that has not previously been exposed to the insecticide.

In a further embodiment the methods and uses of the present invention are applied against pests from the family of Aphididae. More preferably against aphids that are resistant to other insecticides, e.g. pyrethroid insecticides. Such resistant aphids are particularly Aphis gossypii and A. glycines. Aphids that are “resistant” to a particular insecticide refers e.g. to strains of aphids that are less sensitive to that insecticide compared to the expected sensitivity of the same species of aphids. The expected sensitivity can be measured using e.g. a strain that has not previously been exposed to the insecticide.

In a further embodiment the methods and uses of the present invention are applied against pests from the family of Cicadellidae. More preferably against leafhoppers that are resistant to other insecticides, e.g. organophosphate insecticides. Such resistant leafhoppers are particularly Amrasca biguttula biguttula, Empoasca fabae, Epoasca kraemeri, Nephotettk spp. Leaf-hoppers that are “resistant” to a particular insecticide refers e.g. to strains of leafhoppers that are less sensitive to that insecticide compared to the expected sensitivity of the same species of aphids. The expected sensitivity can be measured using e.g. a strain that has not previously been exposed to the insecticide.

In one aspect of the present invention, the method comprises applying to Faboideae plants, crops and/or propagation material, in particular soybean plants, soybean crops and/or propagation material of soybean plants, a compound of formula I, wherein the method is for controlling and/or preventing infestation by pests.

Especially the method is for controlling and/or preventing infestation by pests from the family of Pentatomidae and/or Aleyrodidae (such as Bemisia tabaci) and/or Aphididae (such as Aphis gossypii and Aphis glycines), in particular from the family of Pentatomidae, stink bugs; even more particular for controlling and/or preventing infestation by Acrosternum spp., Euschistus spp., Nezara spp. and/or Piezodrus spp., most particularly by Acrosternum hiare, Euschistus heros, Nezara vindula and/or Piezodrus guildini, and especially by Euschistus heros. Further Pentatomidae pests that can be controlled according to the invention are Eysarcoris, in particular Eysarcoris aeneus (forest shield bug).

A further aspect the invention provides the use of the compounds of formula I for the general control of pests from the family of Pentatomidae (stink bugs) and/or Aleyrodidae, and/or Aphididae, preferably for the control of pests from the family of Pentatomidae, in particular for the control of Acrosternum spp., Euschistus spp., Nezara spp. and/or Piezodrus spp., more preferably for the control of Acrosternum hilare, Euschistus heros, Nezara vifidula and/or Piezodrus guildini, and most preferably for the control of Euschistus heros.

A further aspect the invention provides the use of the compounds of formula I for the general control of pests from the family of Cicadellidae (leafhoppers), preferably for the control of Amrasca biguttula biguttula, Empoasca spp., Circulifer tenellus, Homalodisca vitripennis, Sophonia rufofascia and/or Typhlocyba pomaria, more preferably for the control of Amrasca biguttula biguttula, Empoasca fabae, Empoasca Solana, and/or Epoasca kraemeri.

In another aspect, the present invention provides the use of the compounds of formula I for controlling pests that are resistant to one or more other insecticides, preferably pyrethroids, neonicotinoids and organophosphates, and more preferably pyrethroid insecticides.

Preferably the compounds of formula I the invention are used for controlling pests from the family of Pentatomidae including green stink bug (Acrosternum hilare), brown marmorated stink bug (Halyomorpha halys), redbanded stink bug (Piezodorus guildinii), neotropical brown stink bug (Euschistus heros), brown stink bug (Euschistus servus), kudzu bug (Megacopta cribraria), red-shouldered stink bug (Thyanta custator) and the dusky-brown stink bug (Euschistus tristigmus), the southern green stink bug (Nezara viridula), Aleyrodidae including sweetpotato whitefly (Bemisia tabact), Aphididae including cotton aphid (Aphis gossypii) and soybean aphid (Aphis glycines) and combinations thereof.

In another embodiment, the pests are Thyanta custator.

In another embodiment, the pests are Euschistus tristigmus.

In another embodiment, the pests are Acrosternum hilare.

In another embodiment, the pests are Halyomorpha halys.

In another embodiment, the pests are Piezodorus guildinii.

In another embodiment, the pests are Euschistus heros.

In another embodiment, the pests are Euschistus servus.

In another embodiment, the pests are Megacopta cribraria.

In another embodiment, the pests are Thyanta custator.

In another embodiment, the pests are Euschistus tristigmus.

In another embodiment, the pests are Nezara viridula.

In another embodiment, the pests are Bemisia tabacii.

In another embodiment, the pests are Aphis gossypii.

In another embodiment, the pests are Aphis glycines

In another embodiment, the pests are Amrasca biguttula biguttula.

In another embodiment, the pests are Empoasca fabae.

In another embodiment, the pests are Epoasca kraemeri.

The compounds of formula I are preferably used on Faboideae, in particular soybean, to control stinkbugs, e.g. Nezara spp. (e.g. Nezara viridula, Nezara antennata, Nezara Maris), Piezodorus spp. (e.g. Piezodorus guildinii), Acrosternum spp.(e.g. Acrosternum hilare), Euchistus spp. (e.g. Euchistus heros, Euschistus servus), Halyomorpha halys, Megacopta cribaria, Plautia crossota, Riptortus clavatus, Rhopalus msculatus, Antestiopsis orbitalus, Dectes texanus, Dichelops spp. (e.g. Dichelops furcatus, Dichelops melacanthus), Eurygaster spp. (e.g. Eurygaster intergriceps, Eurygaster maurd), Oebalus spp. (e.g. Oebalus mexicana, Oebalus poecilus, Oebalus pugnase, Scotinophara spp. (e.g. Scotinophara lurida, Scotinophara coarctatd). Preferred targets include Acrosternum hilare, Antestiopsis orbitalus, Dichelops furcatus, Dichelops melacanthus, Euchistus heros, Euschistus servus, Megacopta cribaria, Nezara viridula, Nezara hilare, Piezodorus Halyomorpha halys. In one embodiment the stinkbug target is Nezara viridula, Piezodorus spp., Acrosternum spp., Euchistus heros. Euschistus and in particular Euchistus heros are the preferred targets. More preferably the compounds of formual I are used to control Pentatomidae including green stink bug (Acrosternum hilare), brown marmorated stink bug (Halyomorpha halys), redbanded stink bug (Piezodorus guildinii), neotropical brown stink bug (Euschistus heros), brown stink bug (Euschistus servus), and kudzu bug (Megacopta cribraria).

Further Pentatomidae pests that can be controlled according to the invention are Eysarcoris, in particular Eysarcoris aeneus.

The compounds of formula I are preferably used on Faboideae, in particular soybean, to control whiteflies, e.g. sweetpotato whitefly (Bemisia tabaci).

The compounds of formula I are preferably used on Faboideae, in particular soybean, to control aphids, e.g. soybean aphid (Aphis glycines).

The compounds of formula I are preferably used on Faboideae, in particular soybean, to control leafhoppers, e.g. potato leafhopper (Empoasca fabae).

The compounds of formula I are preferably used on Faboideae, in particular soybean, to control leafhoppers, e.g. Lorito verde (small green pakeet) (Empoasca kraemeri).

Application of the compounds of formula I is preferably to a crop of Faboideae, such as soybean plants, the locus thereof or propagation material thereof. Application may be before infestation or when the pest is present. Application of the compounds of formula I can be performed according to any of the usual modes of application, e.g. foliar, drench, soil, in furrow etc. Control of stinkbugs can be achieved by foliar application, which is a preferred mode of application according to the invention.

In another preferred embodiment, the compounds of formula I are applied to Faboideae crops by soil-drench application. In one preferred embodiment, the Faboideae crops are soybean crops.

In a further preferred embodiment the compounds of formula I are applied as seed-treatment to seeds of Faboideae crops. In one preferred embodiment, the Faboideae crops are soybean crops.

The pest, e.g. the stink bugs, the plant, soil or water in which the plant is growing can be contacted with the compounds of formula I or composition(s) containing them by any further application method known in the art. As such, “contacting” includes both direct contact (applying the compounds/compositions directly on the animal pest or plant—typically to the foliage, stem or roots of the plant) and indirect contact (applying the compounds/compositions to the locus of the animal pest or plant).

The compounds of formula I or the pesticidal compositions comprising them may be used to protect growing plants and crops from attack or infestation by animal pests, especially from stink bugs, in particular from Euschistus, more particularly from E. heros, by contacting the plant/crop with a pesticidally effective amount of compounds of formula I. The term “crop” refers both to growing and harvested crops.

The compounds of formula I may be applied in combination with an attractant. An attractant is a chemical that causes the insect to migrate towards the location of application. For control of stinkbugs it can be advantageous to apply the compounds of formula I with an attractant, particularly when the application is foliar. Stinkbugs are often located near to the ground, and application of an attractant may encourage migration up the plant towards the active ingredient.

Suitable attractants include glucose, sacchrose, salt, glutamate, citric acid, soybean oil, peanut oil and soybean milk. Glutamate and citric acid are of particular interest, with citric acid being preferred.

An attractant may be premixed with the compound of formula I prior to application, e.g. as a readymix or tankmix, or by simultaneous application or sequential application to the plant. Suitable rates of attractants are for example 0.02 kg/ha-3 kg/ha.

The compounds of formula I are preferably used for pest control on Faboideae, in particular soybean, at 1-500 g/ha, preferably 10-150 g/ha.

The compounds of formula I are suitable for use on any such as soybean plants, including those that have been genetically modified to be resistant to active ingredients such as herbicides or to produce biologically active compounds that control infestation by plant pests.

In a further preferred embodiment, transgenic plants and plant cultivars obtained by genetic engineering methods, if appropriate in combination with conventional methods (Genetically Modified Organisms), and parts thereof, are treated. Particularly preferably, plants of the plant cultivars which are in each case commercially available or in use are treated according to the invention. Plant cultivars are understood as meaning plants having novel properties (“traits”) which have been obtained by conventional breeding, by mutagenesis or by recombinant DNA techniques.

These can be cultivars, bio- or genotypes. Depending on the plant species or plant cultivars, their location and growth conditions (soils, climate, vegetation period, diet), the treatment according to the invention may also result in superadditive (“synergistic”) effects.

Preferably the modified plant is “Intacta RR2 PRO” soybean (Monsanto), which claims to offer tolerance to glyphosate herbicide and protection against major soybean pests (velvetbean caterpilar, soybean looper, soybean budborer, bean shoot borer, bollworm, corn stalk borer, Helicoverpa, e.g. Helicoverpa armigera), along with increased yield potential.

Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

The preferred transgenic plants or plant cultivars (obtained by genetic engineering) which are to be treated according to the invention include all plants which, by virtue of the genetic modification, received genetic material which imparts particularly advantageous, useful traits to these plants.

Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products.

Further emphasized examples of such traits are a better defense of the plants against animal and microbial pests, such as against insects, mites, phytopathogenic fungi, bacteria and/or viruses, and also increased tolerance of the plants to certain herbicidally active compounds. Another emphasized example of such traits is an increased tolerance of the plants to certain insecticidally active compounds.

Traits that are emphasized in particular are the increased defense of the plants against insects, arachnids, nematodes and slugs and snails by virtue of toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (referred to herein as “Bt plants”). Traits that are also particularly emphasized are the increased defense of the plants against fungi, bacteria and viruses by systemic acquired resistance (SAR), systemin, phytoalexins, elicitors and resistance genes and correspondingly expressed proteins and toxins.

Traits that are furthermore particularly emphasized are the increased tolerance of the plants to certain herbicidally active compounds, for example imidazolinones, sulphonylureas, glyphosate, or phosphinotricin. The genes which impart the desired traits in question can also be present in combination with one another in the transgenic plants.

Examples of “Bt plants” are soybean varieties, which are sold under the trade name Intacta™ Roundup Ready™ 2 Pro.

Examples of herbicide-tolerant plants which may be mentioned are soya bean varieties which are sold under the trade names Roundup Ready(®) (tolerance to glyphosate), Liberty Link(®) (tolerance to glufosinate), Cultivance® (tolerance to imidazolinones) and Optimum GAT™ (tolerance to sulphonylureas).

Herbicide-resistant plants (plants bred in a conventional manner for herbicide tolerance) which may be mentioned include the varieties sold under the name Clearfield(®) (for example rice, canola, sunflower, wheat).

The method of the invention can be preferably performed on soybean plants, carrying two or more traits (e.g. Enlist®), glyphosate (e.g. Roundup Ready®, Roundup Ready 2 Yield®), sulfonylurea (e.g. Cultivance®), glufosinate (e.g. Liberty Link®, Ignite®), Dicamba (Genuity® Roundup Ready™ 2 Xtend™) HPPD tolerance (e.g. isoxaflutole herbicide) (SYN-000H2-5). Double or triple stack in soybean plants of any of the traits described here are also of interest, including glyphosate and sulfonylurea tolerance (e.g. Optimum GAT®, plants stacked with STS® and Roundup Ready® or Roundup Ready 2 Yield®), dicamba and glyphosate tolerance (Monsanto). Soybean Cyst Nematode resistance soybean (SCN®—Syngenta) and soybean with Aphid resistant trait (AMT®—Syngneta) are also of interest.

These statements also apply to plant cultivars having these genetic traits or genetic traits still to be developed, which plant cultivars will be developed and/or marketed in the future.

As outlined above, the above mentioned pests are of particular importance in connection with soybean plants.

In one embodiment of the above use or method comprising the application of the compounds of formula I, the plant is a plant, which has been modified by conventional breeding, i.e. a plant, which has not been modified by mutagenesis or genetic engineering.

In another embodiment of the above use or method comprising the application of the compounds of formula I, the soybean plant is a plant, which has been modified by mutagenesis or genetic engineering, preferably by genetic engineering.

In a preferred embodiment, in the plant, which has been modified by mutagenesis or genetic engineering, one or more genes have been mutagenized or integrated into the genetic material of the plant, which are selected from epsps, aad-12, avhppd-03, bar, bbx32, cry1A.105, cry1Ac, cry1F, cry2Ab2, csrl-2, dmo, fad2-1A (sense and antisense), fan1 (mutant), fatb1-A (sense and antisense segments), fatb2-1A (sense and antisense), gat4601, gm-fad2-1, gm-hra, hppdPF W336, Nc.fad3, and pat, Pj.D6D.

In another more preferred embodiment, the plant, which has been modified by mutagenesis or genetic engineering (modified plant), exhibits one or more traits selected from the group consisting of abiotic stress tolerance, altered growth/yield, disease resistance, herbicide tolerance, insect resistance, modified product quality, and pollination control. Preferably, the plant exhibits herbicide tolerance, insect resistance, or a combination thereof.

In a preferred embodiment of the use or method as defined above, the plant is a soybean plant, which is a modified plant, and which corresponds to any one of entries of Table A, Table B, or Table C.

TABLE A
Soybean (Glycine max) plants

| No. | Event Name | Event Code | Tradename | Trait Type & Genes | Company |
|---|---|---|---|---|---|
| A1 | 260-05 (G94-1, | DD-Ø26ØØ5-3 | | ST (Oil)/gm-fad2-1 | Dupont |
| | G94-19, G168) | | | (silencing locus) | |
| A2 | A2704-12 | ACS-GMØØ5-3 | Liberty Link ™ | HT (Glu)/pat | Bayer Crop |
| | | | soybean | | Science |
| A3 | A2704-21 | ACS-GMØØ4-2 | Liberty Link ™ | HT (Glu)/pat | Bayer Crop |
| | | | soybean | | Science |
| A4 | A5547-127 | ACS-GMØØ6-4 | Liberty Link ™ | HT (Glu)/pat | Bayer Crop |
| | | | soybean | | Science |
| A5 | A5547-35 | ACS-GMØØ8-6 | Liberty Link ™ | HT (Glu)/pat | Bayer Crop |
| | | | soybean | | Science |
| A6 | CV127 | BPS-CV127-9 | Cultivance | HT (Imi)/csr1-2 | BASF |
| A7 | DAS44406-6 | DAS-444Ø6-6 | | HT (2,4-D)/aad-12 | Dow |
| | | | | HT (Gly)/2mepsps | |
| | | | | HT (Glu)/pat | |
| A8 | DAS68416-4 | DAS-68416-4 | Enlist ™ | HT (2,4-D)/aad-12 | Dow |
| | | | Soybean | HT (Glu)/pat | |
| A9 | DAS68416-4 × | DAS-68416-4 × | | HT (2,4-D)/aad-12 | Dow |
| | MON89788 | MON-89788-1 | | HT (Glu)/pat | |
| | | | | HT (Gly)/cp4 epsps | |
| | | | | (aroA:CP4) | |
| A10 | DAS81419 | DAS-81419-2 | | IR (BL)/cry1Ac | Dow |
| | | | | IR(BL)/cry1F | |
| A11 | DP305423 | DP-3Ø5423-1 | Treus ™, | ST (Oil)/gm-fad2-1 | Dupont |
| | | | Plenish ™ | (partial sequence) | |
| A12 | DP305423 × | DP-3Ø5423-1 × | | ST (Oil)/gm-fad2-1 | Dupont |
| | GTS 40-3-2 | MON-Ø4Ø32-6 | | (partial sequence) | |
| | | | | HT (Gly)/cp4 epsps | |
| | | | | (aroA:CP4) | |
| A13 | DP356043 | DP-356Ø43-5 | Optimum | HT (Gly)/gat4601 | Dupont |
| | | | GAT ™ | HT (SU)/gm-hra | |
| A14 | FG72 | MST-FGØ72-3 | | HT (Gly)/2mepsps | Bayer Crop- |
| | (FGØ72-2, | | | HT (HPPD)/hppdPF | Science and |
| | FGØ72-3) | | | W336 | MS Technologies |
| | | | | | LLC |
| A15 | GTS 40-3-2 | MON-Ø4Ø32-6 | Roundup | HT (Gly)/cp4 epsps | Monsanto |
| | (40-3-2) | | Ready ™ | (aroA:CP4) | |
| | | | soybean | | |
| A16 | GU262 | ACS-GMØØ3-1 | Liberty Link ™ | HT (Glu)/pat | Bayer Crop |
| | | | soybean | | Science |
| A17 | MON 87712 | MON-87712-4 | Not available | YS (Y)/bbx32 | Monsanto |
| A18 | MON87701 | MON-877Ø1-2 | | IR (BL)/cry1Ac | Monsanto |
| A19 | MON87701 × | MON-877Ø1-2 × | Intacta ™ | IR (BL)/cry1Ac | Monsanto |
| | MON89788 | MON-89788-1 | Roundup | HT (Gly)/cp4 epsps | |
| | | | Ready ™ 2 | (aroA:CP4) | |
| | | | Pro | | |
| A20 | MON87705 | MON-877Ø5-6 | Vistive Gold ™ | ST (Oil)/fatb1-A | Monsanto |
| | | | | (sense and antisense | |
| | | | | segments) | |
| | | | | ST (Oil)/fatb2-1A | |
| | | | | (sense and antisense) | |
| | | | | HT (Gly)/cp4 epsps | |
| | | | | (aroA:CP4) | |
| A21 | MON87705 × | MON-877Ø5-6 × | | ST (Oil)/fatb1-A | Monsanto |
| | MON89788 | MON-89788-1 | | (sense and antisense | |
| | | | | segments) | |
| | | | | ST (Oil)/fatb2-1A | |
| | | | | (sense and antisense) | |
| | | | | HT (Gly)/cp4 epsps | |
| | | | | (aroA:CP4) | |
| A22 | MON87708 | MON-877Ø8-9 | Genuity ® | HT (Dic)/dmo | Monsanto |
| | | | Roundup | | |
| | | | Ready ™ 2 | | |
| | | | Xtend ™ | | |
| A23 | MON87708 × | MON-877Ø8-9 × | | HT (Dic)/dmo | Monsanto |
| | MON89788 | MON-89788-1 | | HT (Gly)/cp4 epsps | |
| | | | | (aroA:CP4) | |
| A24 | MON87751 | MON-87751-7 | | IR (BL)/cry1A.105 | Monsanto |
| | | | | IR (BL)/cry2Ab2 | |
| A25 | MON87769 | MON87769-7 | | ST (Oil)/Pj.D6D | Monsanto |
| | | | | ST (Oil)/Nc.fad3 | |
| A26 | MON87769 × | MON-87769-7 × | | ST (Oil)/Pj.D6D | Monsanto |
| | MON89788 | MON-89788-1 | | ST (Oil)/Nc.fad3 | |
| | | | | HT (Gly)/cp4 epsps | |
| | | | | (aroA:CP4) | |
| A27 | MON89788 | MON-89788-1 | Genuity ® | HT (Gly)/cp4 epsps | Monsanto |
| | | | Roundup | (aroA:CP4) | |
| | | | Ready 2 | | |
| | | | Yield ™ | | |
| A28 | SYHTØH2 | SYN-ØØØH2-5 | Herbicide- | HT (Glu)/pat HT | Bayer Crop |
| | | | tolerant | (HPPD)/ | Science & |
| | | | Soybean line | avhppd-03 | Syngenta |
| A29 | W62 | ACS-GMØØ2-9 | Liberty Link ™ | HT (Glu)/bar | Bayer Crop |
| | | | soybean | | Science |
| A30 | W98 | ACS-GMØØ1-8 | Liberty Link ™ | HT (Glu)/bar | Bayer Crop |
| | | | soybean | | Science |
| A31 | OT96-15 | OT96-15 | | ST (Oil)/fan1 | Agriculture & |
| | | | | (mutant) | Agri-Food |
| | | | | | Canada |
| A32 | MON87712 | MON-87712-4 | | HT (Gly)/cp4 epsps | Monsanto |
| | | | | (aroA:CP4) | |
| | | | | YS (Y) bbx32 | |
| A33 | MON87705 × | MON-877Ø5-6 × | | ST (Oil)/fatb1-A | Syngenta |
| | MON87708 × | MON-877Ø8-9 × | | (sense and antisense | |
| | MON89788 | MON-89788-1 | | segments) | |
| | | | | ST (Oil)/fat2-1A | |
| | | | | (sense and antisense) | |
| | | | | HT (Gly)/cp4 epsps | |
| | | | | (aroA:CP4) | |
| | | | | HT (Dic)/dmo | |

The plants listed in Table A are known from “International Service for the Acquisition of Agribiotech Applications” (ISAAA), which database is accessible in the internet under: http://www.isaaa.org/gmapprovaldatabase/default.asp

Explanations:

| TRAIT | TRAIT - full name | TRAIT TYPE | TRAIT TYPE - full name |
|---|---|---|---|
| HT | Herbicide Tolerance | HT (Gly) | glyphosate tolerance |
| | | HT (Glu) | glufosinate tolerance |
| | | HT (SU) | sulfonylurea tolerance |
| | | HT (Imi) | imidazolinone tolerance |
| | | HT (2,4-D) | resistance against 2,4-D Choline |
| | | HT (Dic) | dicamba tolerance |
| | | HT (Gly + Dicamba) | glyphosate & dicamba tolerance |
| | | HT (HPPD) | HPPD inhibitor resistance |
| | | HT (Ox) | oxynil herbicide tolerance (e.g. |
| | | | bromoxynil) |
| | | HT (Cyc) | cyclohexanone herbicide tolerance |
| | | | (e.g. sethoxydim) |
| | | 2HT | two genes for same HT-trait |
| IR | Insect resistance | IR (BL) | broad spectrum resistance |
| | (including Nematodes) | | against lepidopterans (above |
| | | | ground worms) |
| | | IR (Col) | resistance against Coleopterans |
| | | | (beetles) |
| | | IR (SCN) | soybean Cyst Nematode |
| | | | resistance |
| | | IR (CB) | corn borer resistance |
| | | IR (BRun) | broad range resistance, not further |
| | | | specified |
| | | IR (Rw) | resistance against root worm |
| PC | Pollination control and | PC (FR) | fertility restoration |
| | male sterility systems | | |
| | | PC (MS) | male sterility |
| FR | Fungal resistance | FR (SR) | stalk rot resistance |
| VR | Viral resistance | VR (BGMV) | resistance to Bean Golden Mosaic |
| | | | Virus |
| | | VR (PRSV) | resistance to papaya ringspot virus |
| | | VR (PPV) | resistance to plum pox virus |
| | | VR (PVY) | resistance to potato virus Y |
| | | VR (PLRV) | resistance to potato leafroll virus |
| | | VR (CMV) | resistance to cucumber mosaic |
| | | | cucumovirus |
| | | VR (ZYMV) | resistance to zucchini yellow mosaic |
| | | | potyvirus |
| | | VR (WMV) | resistance to watermelon mosaic |
| | | | potyvirus 2 |
| Y&S | Yield and Stress | Y&S (DT) | drought tolerance |
| | | Y&S (Y) | yield increase |
| | | Y&S (NUE) | nitrogen use efficiency |
| ST | Specialty Trait (includes | ST (Lignin) | altered lignin production |
| | Feed, Food, Quality) | | |
| | | ST (OIL) | altered oil content |
| | | ST (starch) | altered starch content |
| | | ST (CA) | corn amylase |
| | | ST (P) | phytase production |
| | | ST (Color) | modified color |
| | | ST (Ripe) | delayed/altered ripening |
| | | ST (AA) | altered amino-acid content |
| | | ST (All) | anti-allergy |
| | | ST (Nic) | altered nicotin content |
| | | ST (BSB) | reduced black spot bruise formation |
| SM | Selectable marker | | |

Preferred soybean plants include the soybean plants according to any one row of table B:

TABLE B

| | | | Developer/ |
|---|---|---|---|
| No | Trait(s) | Event name | commercial plants |
| B-1 | Glufosinate tolerance + | DAS81419 | Dow AgroSciences |
| | Lepidopteran resistance | LLC | |
| B-2 | Lepidopteran resistance | MON87701 | Monsanto Company |
| B-3 | Glyphosate tolerance + | MON87701 × | available, Monsanto |
| | Lepidopteran resistance | MON89788 | Company; Intacta ™ |
| | | | Roundup Ready ™ 2 |
| | | | Pro |
| B-4 | Lepidopteran resistance | MON87751 | Monsanto Company |

Preferred soybean plants include soybean plants, which have been modified by integrating at least one gene or gene combination according to one row of Table C:

TABLE C

| | Gene for | Gene for | Gene for | Gene for |
|---|---|---|---|---|
| | lepidopteran | lepidopteran | lepidopteran | herbicide |
| No. | resistance | resistance | resistance | tolerance |
| C-1 | cry1Ac | | | |
| C-2 | cry1A.105 | | | |
| C-3 | cry2Ab2 | | | |
| C-4 | cry1F | | | |
| C-5 | cry1Ac | cry1A.105 | | |
| C-6 | cry1Ac | cry2Ab2 | | |
| C-7 | cry1Ac | cry1F | | |
| C-8 | cry1A.105 | cry2Ab2 | | |
| C-9 | cry1A.105 | cry1F | | |
| C-10 | cry2Ab2 | cry1F | | |
| C-11 | cry1Ac | cry1A.105 | cry2Ab2 | |
| C-12 | cry1F | cry1A.105 | cry2Ab2 | |
| C-13 | cry1Ac | cry1F | cry2Ab2 | |
| C-14 | cry1Ac | cry1A.105 | cry1F | |
| C-15 | cry1Ac | | | pat |
| C-16 | cry1A.105 | | | pat |
| C-17 | cry2Ab2 | | | pat |
| C-18 | cry1F | | | pat |
| C-19 | cry1Ac | cry1A.105 | | pat |
| C-20 | cry1Ac | cry2Ab2 | | pat |
| C-21 | cry1Ac | cry1F | | pat |
| C-22 | cry1A.105 | cry2Ab2 | | pat |
| C-23 | cry1A.105 | cry1F | | pat |
| C-24 | cry2Ab2 | cry1F | | pat |
| C-25 | cry1Ac | cry1A.105 | cry2Ab2 | pat |
| C-26 | cry1F | cry1A.105 | cry2Ab2 | pat |
| C-27 | cry1Ac | cry1F | cry2Ab2 | pat |
| C-28 | cry1Ac | cry1A.105 | cry1F | pat |
| C-29 | cry1Ac | | | bar |
| C-30 | cry1A.105 | | | bar |
| C-31 | cry2Ab2 | | | bar |
| C-32 | cry1F | | | bar |
| C-33 | cry1Ac | cry1A.105 | | bar |
| C-34 | cry1Ac | cry2Ab2 | | bar |
| C-35 | cry1Ac | cry1F | | bar |
| C-36 | cry1A.105 | cry2Ab2 | | bar |
| C-37 | cry1A.105 | cry1F | | bar |
| C-38 | cry2Ab2 | cry1F | | bar |
| C-39 | cry1Ac | cry1A.105 | cry2Ab2 | bar |
| C-40 | cry1F | cry1A.105 | cry2Ab2 | bar |
| C-41 | cry1Ac | cry1F | cry2Ab2 | bar |
| C-42 | cry1Ac | cry1A.105 | cry1F | bar |
| C-43 | cry1Ac | | | 2mepsps |
| C-44 | cry1A.105 | | | 2mepsps |
| C-45 | cry2Ab2 | | | 2mepsps |
| C-46 | cry1F | | | 2mepsps |
| C-47 | cry1Ac | cry1A.105 | | 2mepsps |
| C-48 | cry1Ac | cry2Ab2 | | 2mepsps |
| C-49 | cry1Ac | cry1F | | 2mepsps |
| C-50 | cry1A.105 | cry2Ab2 | | 2mepsps |
| C-51 | cry1A.105 | cry1F | | 2mepsps |
| C-52 | cry2Ab2 | cry1F | | 2mepsps |
| C-53 | cry1Ac | cry1A.105 | cry2Ab2 | 2mepsps |
| C-54 | cry1F | cry1A.105 | cry2Ab2 | 2mepsps |
| C-55 | cry1Ac | cry1F | cry2Ab2 | 2mepsps |
| C-56 | cry1Ac | cry1A.105 | cry1F | 2mepsps |
| C-57 | cry1Ac | | | cp4 epsps |
| C-58 | cry1A.105 | | | cp4 epsps |
| C-59 | cry2Ab2 | | | cp4 epsps |
| C-60 | cry1F | | | cp4 epsps |
| C-61 | cry1Ac | cry1A.105 | | cp4 epsps |
| C-62 | cry1Ac | cry2Ab2 | | cp4 epsps |
| C-63 | cry1Ac | cry1F | | cp4 epsps |
| C-64 | cry1A.105 | cry2Ab2 | | cp4 epsps |
| C-65 | cry1A.105 | cry1F | | cp4 epsps |
| C-66 | cry2Ab2 | cry1F | | cp4 epsps |
| C-67 | cry1Ac | cry1A.105 | cry2Ab2 | cp4 epsps |
| C-68 | cry1F | cry1A.105 | cry2Ab2 | cp4 epsps |
| C-69 | cry1Ac | cry1F | cry2Ab2 | cp4 epsps |
| C-70 | cry1Ac | cry1A.105 | cry1F | cp4 epsps |
| C-71 | cry1Ac | | | mepsps |
| C-72 | cry1A.105 | | | mepsps |
| C-73 | cry2Ab2 | | | mepsps |
| C-74 | cry1F | | | mepsps |
| C-75 | cry1Ac | cry1A.105 | | mepsps |
| C-76 | cry1Ac | cry2Ab2 | | mepsps |
| C-77 | cry1Ac | cry1F | | mepsps |
| C-78 | cry1A.105 | cry2Ab2 | | mepsps |
| C-79 | cry1A.105 | cry1F | | mepsps |
| C-80 | cry2Ab2 | cry1F | | mepsps |
| C-81 | cry1Ac | cry1A.105 | cry2Ab2 | mepsps |
| C-82 | cry1F | cry1A.105 | cry2Ab2 | mepsps |
| C-83 | cry1Ac | cry1F | cry2Ab2 | mepsps |
| C-84 | cry1Ac | cry1A.105 | cry1F | mepsps |

In a preferred embodiment of the use or method as defined above, the plant is a soybean plant, which is a modified plant, and which corresponds to any one of rows of Table I:

TABLE I

| No. | Event Name | Trait Genes |
|---|---|---|
| I-1 | 260-05 (G94-1, G94-19, G168) | ST (Oil)/gm-fad2-1 |
| | | (silencing locus) |
| I-2 | A2704-12 | HT (Glu)/pat |
| I-3 | A2704-21 | HT (Glu)/pat |
| I-4 | A5547-127 | HT (Glu)/pat |
| I-5 | A5547-35 | HT (Glu)/pat |
| I-6 | CV127 | HT (Imi)/csr1-2 |
| I-7 | DAS44406-6 | HT (2,4-D)/aad-12 |
| | | HT (Gly)/2mepsps |
| | | HT (Glu)/pat |
| I-8 | DAS68416-4 | HT (2,4-D)/aad-12 |
| | | HT (Glu)/pat |
| I-9 | DAS68416-4 × MON89788 | HT (2,4-D)/aad-12 |
| | | HT (Glu)/pat |
| | | HT (Gly)/cp4 epsps (aroA:CP4) |
| I-10 | DAS81419 | IR (BL)/cry1Ac |
| | | IR (BL)/cry1F |
| I-11 | DP305423 | ST (Oil)/gm-fad2-1 (partial |
| | | sequence) |
| I-12 | DP305423 × GTS 40-3-2 | ST (Oil)/gm-fad2-1 (partial |
| | | sequence) |
| | | HT (Gly)/cp4 epsps (aroA:CP4) |
| I-13 | DP356043 | HT (Gly)/gat4601 |
| | | HT (SU)/gm-hra |
| I-14 | FG72 (FGØ72-2, FGØ72-3) | HT (Gly)/2mepsps |
| | | HT (HPPD)/hppdPF W336 |
| I-15 | GTS 40-3-2 (40-3-2) | HT (Gly)/cp4 epsps (aroA:CP4) |
| I-16 | GU262 | HT (Glu)/pat |
| I-17 | MON 87712 | YS (Y)/bbx32 |
| I-18 | MON87701 | IR (BL)/cry1Ac |
| I-19 | MON87701 × MON89788 | IR (BL)/cry1Ac |
| | | HT (Gly)/cp4 epsps (aroA:CP4) |
| I-20 | MON87705 | ST (Oil)/fatb1-A (sense and |
| | | antisense segments) |
| | | ST (Oil)/fatb2-1A (sense and |
| | | antisense) |
| | | HT (Gly)/cp4 epsps (aroA:CP4) |
| I-21 | MON87705 × MON89788 | ST (Oil)/fatb1-A (sense and |
| | | antisense segments) |
| | | ST (Oil)/fatb2-1A (sense and |
| | | antisense) |
| | | HT (Gly)/cp4 epsps (aroA:CP4) |
| I-22 | MON87708 | HT (Dic)/dmo |
| I-23 | MON87708 × MON89788 | HT (Dic)/dmo |
| | | HT (Gly)/cp4 epsps (aroA:CP4) |
| I-24 | MON87751 | IR (BL)/cry1A.105 |
| | | IR (BL)/cry2Ab2 |
| I-25 | MON87769 | ST (Oil)/Pj.D6D |
| | | ST (Oil)/Nc.fad3 |
| I-26 | MON87769 × MON89788 | ST (Oil)/Pj.D6D |
| | | ST (Oil)/Nc.fad3 |
| | | HT (Gly)/cp4 epsps (aroA:CP4) |
| I-27 | MON89788 | HT (Gly)/cp4 epsps (aroA:CP4) |
| I-28 | SYHTØH2 | HT (Glu)/pat |
| | | HT (HPPD)/avhppd-03 |
| I-29 | W62 | HT (Glu)/bar |
| I-30 | W98 | HT (Glu)/bar |
| I-31 | OT96-15 | ST (Oil)/fan1 (mutant) |
| I-32 | MON87712 | HT (Gly)/cp4 epsps (aroA:CP4) |
| | | YS (Y) bbx32 |
| I-33 | MON87705 × MON87708 × | ST (Oil)/fatb1-A (sense and |
| | MON89788 | antisense segments) |
| | | ST (Oil)/fat2-1A (sense and |
| | | antisense) |
| | | HT (Gly)/cp4 epsps (aroA:CP4) |
| | | HT (Dic)/dmo |

In view of the above preferences regarding pests and plants, the following embodiments of the use or method of the invention comprising the application of the compounds of formula I are particularly preferred.

In one preferred embodiment of the invention, the present invention relates to the use or method comprising the application of the compounds of formula I as defined above, wherein the pests are selected from the group consisting of green stink bug (Acrosternum hilare), brown marmorated stink bug (Halyomorpha halys), redbanded stink bug (Piezodorus guildinii), neo-tropical brown stink bug (Euschistus heros), brown stink bug (Euschistus servus), kudzu bug (Megacopta cribraria), red-shouldered stink bug (Thyanta custator) and the dusky-brown stink bug (Euschistus tristigmus), the southern green stink bug (Nezara viridula), and combinations thereof, and the plant is a modified soybean plant, and is preferably selected from the plants listed in Tables A, B, and C.

In one particularly preferred embodiment, the pests are Acrosternum hilare and the plant is a soybean plant selected from the plants listed in Tables A, B, and C.

In one particularly preferred embodiment, the pests are Halyomorpha halys and the plant is a soybean plant selected from the plants listed in Tables A, B, and C.

In one particularly preferred embodiment, the pests are Piezodorus guildinii and the plant is a soybean plant selected from the plants listed in Tables A, B, and C.

In one particularly preferred embodiment, the pests are Euschistus heros and the plant is a soybean plant selected from the plants listed in Tables A, B, and C.

In one particularly preferred embodiment, the pests are Megacopta cribraria and the plant is a soybean plant selected from the plants listed in Tables A, B, and C.

In one particularly preferred embodiment, the pests are Thyanta custator and the plant is a soybean plant selected from the plants listed in Tables A, B, and C.

In one particularly preferred embodiment, the pests are Euschistus tristigmus and the plant is a soybean plant selected from the plants listed in Tables A, B, and C.

In one particularly preferred embodiment, the pests are Nezara vindula and the plant is a soybean plant selected from the plants listed in Tables A, B, and C.

In another embodiment, the commercial transgenic plant is a soybean variety selected from “Roundup Ready 2 Yield”, “Intacta RR2 Pro” and “Vistive Gold” (all Monsanto), or “Stearidonic Acid (SDA) Omega-3” (higher content of SDA in soybean, Monsanto). In another embodiment, the trait is Bacillus thuringiensis Cry1A.105 and cry2Ab2 and Vector PV-GMIR13196, for Mon87751 soybean (Monsanto).

In a more preferred embodiment of such embodiment, in the modified plant, one or more genes have been mutagenized or integrated into the genetic material of the plant, which are selected from pat, epsps, cry1Ab, bar, cry1Fa2, cry1Ac, cry34Ab1, cry35AB1, cry3A, cryF, crylF, mcry3a, cry2Ab2, cry3Bb1, cry1A.105, dfr, barnase, vip3Aa20, barstar, als, bxn, bp40, asn1, and ppo5.

In another more preferred embodiment, the modified plant, exhibits one or more traits selected from the group consisting of abiotic stress tolerance, altered growth/yield, disease resistance, herbicide tolerance, insect resistance, modified product quality, and pollination control. Preferably, the plant exhibits herbicide tolerance, insect resistance or a combination thereof.

The compounds of formula I may be applied in the methods of the present invention in mixtures with fertilizers (for example nitrogen-, potassium- or phosphorus-containing fertilizers). Suitable formulation types include granules of fertilizer. The mixtures preferably contain up to 25% by weight of the compound of formula I.

The compositions of this invention may contain other compounds II having biological activity, for example micronutrients or compounds having fungicidal activity or which possess plant growth regulating, herbicidal, insecticidal, nematicidal or acaricidal activity.

The compounds applied in the methods of the present invention may be the sole active ingredient of the composition or it may be admixed with one or more additional active ingredients II such as a pesticide, fungicide, synergist, herbicide or plant growth regulator where appropriate. An additional active ingredient may: provide a composition having a broader spectrum of activity or increased persistence at a locus; synergize the activity or complement the activity (for example by increasing the speed of effect or overcoming repellency) of the compound of formula I; or help to overcome or prevent the development of resistance to individual components. The particular additional active ingredient will depend upon the intended utility of the composition.

According to one embodiment of the present invention, individual components of the composition according to the invention such as parts of a kit or parts of a binary or ternary mixture may be mixed by the user himself in a spray tank and further auxiliaries may be added, if appropriate.

The compounds of formula I may be mixed with soil, peat or other rooting media for the protection of plants against seed-borne, soil-borne or foliar fungal diseases.

Examples of suitable compounds II for use in the compositions include abamectin, acetamiprid, α-cypermethrin, clothianidin, dinotefuran, fludioxonil, spinosad, spirotetramat, sulfoxaflor, fipronil, thiacloprid, afidopyropen, chloranthraniliprole, cyanthraniliprole, imidacloprid, pymetrozine, amectoctradin, chlorothalonil, propiconazole, benthiavalicarb, difenoconazole, dimethomorph, epoxiconazole, prochloraz, boscalid, carbendazim, fluoxastrobin, prochloraz, azoxystrobin, picoxystrobin, pyraclostrobin, fenhexamide, floxapyroxad, trifloxystrobin, tebuconazole, triticonazole, mefenoxam, dithianon, mancozeb, propineb, metconazole, thiabendazole.

Suitable herbicides and plant-growth regulators for inclusion in the compositions will depend upon the intended target and the effect required.

In the following, suitable formulations and applications in connection with the present application are disclosed. These preferred embodiments relate (1) to the mixture of the invention comprising a pyrazole compound of formula I as well as uses and methods comprising the application of said mixture and (2) to uses and methods comprising the application of a compound of formula I according to the invention.

The mixture of the invention or the compound of formula I may be provided in the form of an agrochemical composition comprising a compound of formula I together with one or more other pesticidal active ingredient(s) and an auxiliary.

The formulations comprising a compound of formula I of the present invention can be converted into customary types of agrochemical compositions, e. g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Mono-graph No. 2, 6th Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Examples for suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharide powders, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol.1: Emulsifiers & Detergents, McCutcheon's Directories, Glen Rock, USA, 2008 (International Ed. or North American Ed.)

Suitable anionic surfactants are alkali, alkaline earth or ammonium salts of sulfonates, sulfates, phosphates, carboxylates, and mixtures thereof. Examples of sulfonates are alkylaryl-sulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl naphthalenes, sulfosuccinates or sulfosuccinamates. Examples of sulfates are sulfates of fatty acids and oils, of ethoxylated alkylphenols, of alcohols, of ethox-ylated alcohols, or of fatty acid esters. Examples of phosphates are phosphate esters. Exam-ples of carboxylates are alkyl carboxylates, and carboxylated alcohol or alkylphenol eth-oxylates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the ative ingredients(s) on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates. Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for composition types and their preparation are:

i) Water-soluble concentrates (SL, LS)
10-60 wt % of the pesticidal active compound(s), and 5-15 wt % wetting agent (e.g. alcohol alkoxylates) are dissolved in water and/or in a water-soluble solvent (e.g. alcohols) up to 100 wt %. The active substance dissolves upon dilution with water.

ii) Dispersible concentrates (DC)
5-25 wt % of the pesticidal active compound(s), and 1-10 wt % dispersant (e. g. polyvi-nylpyrrolidone) are dissolved in up to 100 wt % organic solvent (e.g. cyclohexanone). Dilution with water gives a dispersion.

iii) Emulsifiable concentrates (EC)
15-70 wt % of the pesticidal active compound(s), and 5-10 wt % emulsifiers (e.g. calcium dodecylbenzenesulfonate and castor oil ethoxylate) are dissolved in up to 100 wt % water-insoluble organic solvent (e.g. aromatic hydrocarbon). Dilution with water gives an emulsion.

iv) Emulsions (EW, EO, ES)
5-40 wt % of the pesticidal active compound(s), and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into up to 100 wt % water by means of an emulsifying machine and made into a homogeneous emulsion. Dilution with water gives an emulsion.
v) Suspensions (SC, OD, FS)

In an agitated ball mill, 20-60 wt % of the pesticidal active compound(s), are comminuted with addition of 2-10 wt % dispersants and wetting agents (e.g. sodium lignosulfonate and alcohol ethoxylate), 0,1-2 wt % thickener (e.g. xanthan gum) and up to 100 wt % water to give a fine active substance suspension. Dilution with water gives a stable suspension of the active substance. For FS type composition up to 40 wt % binder (e.g. polyvinylalcohol) is added.

vi) Water-dispersible granules and water-soluble granules (WG, SG)
50-80 wt % of the pesticidal active compound(s), are ground finely with addition of up to 100 wt % dispersants and wetting agents (e.g. sodium lignosulfonate and alcohol ethoxylate) and prepared as water-dispersible or water-soluble granules by means of technical appliances (e. g. extrusion, spray tower, fluidized bed). Dilution with water gives a stable dispersion or solution of the active substance.

vii) Water-dispersible powders and water-soluble powders (WP, SP, WS)
50-80 wt % of the pesticidal active compound(s), are ground in a rotor-stator mill with ad-dition of 1-5 wt % dispersants (e.g. sodium lignosulfonate), 1-3 wt % wetting agents (e.g. alcohol ethoxylate) and up to 100 wt % solid carrier, e.g. silica gel. Dilution with water gives a stable dis-persion or solution of the active substance.

viii) Microemulsion (ME)
5-20 wt % of the pesticidal active compound(s), are added to 5-30 wt % organic solvent blend (e.g. fatty acid dimethylamide and cyclohexanone), 10-25 wt % surfactant blend (e.g. alkohol ethoxylate and arylphenol ethoxylate), and water up to 100%. This mixture is stirred for 1 h to produce spontaneously a thermodynamically stable microemulsion.

ix) Microcapsules (CS)
An oil phase comprising 5-50 wt % of the pesticidal active compound(s), 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radi-cal initiator results in the formation of poly(meth)acrylate microcapsules. Alternatively, an oil phase comprising 5-50 wt % of the pesticidal active compound(s), 0-40 wt % water insoluble organic solvent (e.g. aromatic hydrocarbon), and an isocyanate monomer (e.g. diphenylme-thene-4,4′-diisocyanatae) are dispersed into an aqueous solution of a protective colloid (e.g. polyvinyl alcohol). The addition of a polyamine (e.g. hexamethylenediamine) results in the for-mation of a polyurea microcapsule. The monomers amount to 1-10 wt %. The wt % relate to the total CS composition.

x) Dustable powders (DP, DS)
1-10 wt % of pesticidal active compound(s), are ground finely and mixed intimately with up to 100 wt % solid carrier, e.g. finely divided kaolin.

xi) Granules (GR, FG)
0.5-30 wt % of v, is ground finely and associated with up to 100 wt % solid carrier (e.g. silicate). Granulation is achieved by extrusion, spray-drying or the fluidized bed.

xii) Ultra-low volume liquids (UL)
1-50 wt % of pesticidal active compound(s), are dissolved in up to 100 wt % organic solvent, e.g. aromatic hydrocarbon.

The compositions types i) to x) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally comprise between 0.01 and 95%, preferably between 0.1 and 90%, and most preferably between 0.5 and 75%, by weight of active substance.

The active substances are employed in a purity of from 90% to 100%, preferably from 95% to 100% (according to NMR spectrum).

Various types of oils, wetters, adjuvants, fertilizer, or micronutrients, and other pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage de-vice, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components, e.g. components comprising pesticidal active compound(s), may be mixed by the user in a spray tank and further auxiliaries and additives may be added, if appropriate.

In a further embodiment, either individual components of the composition according to the invention or partially premixed components, e. g. components comprising pesticidal active compound(s), can be applied jointly (e.g. after tank mix) or consecutively.

Conventional seed treatment formulations include for example flowable concentrates FS, solutions LS, suspoemulsions (SE), powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter. Preferably, the formulations are applied such that germination is not included.

The active substance concentrations in ready-to-use formulations, which may be obtained after two-to-tenfold dilution, are preferably from 0.01 to 60% by weight, more preferably from 0.1 to 40% by weight.

In a preferred embodiment a FS formulation is used for seed treatment. Typically, a FS formulation may comprise 1-800 g/l of active ingredient, 1-200 g/l Surfactant, 0 to 200 g/l antifreezing agent, 0 to 400 g/l of binder, 0 to 200 g/l of a pigment and up to 1 liter of a solvent, preferably water. Especially preferred FS formulations of the compounds of formula I, preferably one of compounds I-1, I-2, and I-3, for seed treatment usually comprise from 0.1 to 80% by weight (1 to 800 g/l) of the active ingredient, from 0.1 to 20% by weight (1 to 200 g/l) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker /adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

In the treatment of seed, the application rates of the pyrazole compounds of formula I, are generally from 0.1 g to 10 kg per 100 kg of seed, preferably from 1 g to 5 kg per 100 kg of seed, more preferably from 1 g to 1000 g per 100 kg of seed and in particular from 1 g to 200 g per 100 kg of seed, e.g. from 1 g to 100 g or from 5 g to 100 g per 100 kg of seed.

The invention therefore also relates to seed comprising one of the pyrazole compound of formula (I). The amount of the pyrazole compound of formula (I) will in general vary from 0.1 g to 10 kg per 100 kg of seed, preferably from 1 g to 5 kg per 100 kg of seed, in particular from 1 g to 1000 g per 100 kg of seed. For specific crops such as lettuce the rate can be higher.

### EXAMPLE

The present invention may be illustrated by the following example.

The biological activity and effectivity of the compounds applied in the methods of the invention can be evaluated e.g. in the following assay.

The active compound tested was formulated as a SL-type formulation. 2.5 ml of formulation were diluted per liter water to achieve the final concentration tested as shown in table 1.

Action on Sweetpotato whitefly (Bemisia tabaci)

A randomized block, 2 by 3 factorial experimental design was utilized to determine the interaction effects and main effects of two explanatory variables: product rate and soybean variety on the response variable, whitefly mortality. The study was conducted under greenhouse conditions and utilized lntacta™ (Bt-traited) and ‘BMX Potencia’ (non-traited) varieties at growth stage 11, respectively. All study plants were infested with Bemisia tabaciadults prior to application.

Formulated material of compound I-1 was combined with water and applied at concentration of 60 gai/ha with a CO₂ pressurized spray boom at 200 L/ha water volume. The first application was timed to a threshold whitefly infestation, and was followed by a second application 7 days later.

Assessments were conducted by taking whole plant counts of adult and immature whiteflies at 3 days after the second application.

Compound I-1 generated the following mortality response:

TABLE 1
Mean whitefly nymph response at 3 days after 2^{nd} application

| | dose | Whitefly Nymphs |
|---|---|---|
| Product | ppm a.i. | D.A.A.-2 |
| Untreated INTACTA ™ | — | 2.52 |
| Untreated BMX Potencia | — | 5.65 |
| I-1 + INTACTA ™ | 60 | 0.57 |
| I-1 + BMX Potencia | 60 | 4.91 |

According to G. de Kerchove, A Statistical Handbook for Agricultural Field Trials Specialists. 2^{nd} Edition, Middletown, DE: ARM, 2016, pg. 58; the interaction effect between two factors determines the appropriate analysis method. In this case, the interaction effect between treatment rate and variety (AB) was not significant at the 5% level (Table 1). Therefore, each factor A & B were considered independent and treatment means were analyzed by multiple comparison analysis (ANOVA). Whitefly nymphs exposed to 60 g a.i./ha of compound I-1 experienced significantly significantly reduced survivorship in Intacta™ soybean (p=0.57) relative to the BMX Potencia (p=4.91) at 3 days after second application. These results demonstrate a synergistic effect imposed by I-1 against whiteflies in Intacta™ soybean that is independent of an interaction effect between rate and variety.

1-15. (canceled)

16. A method for controlling pests selected from are Aleyrodidae (whiteflies), Aphididae, and Pentatomidae (stink bugs) of genetically modified Bt plants, comprising the step of contacting the plant, parts of it, its propagation material, the pests, their food supply, habitat or breeding grounds with the pyrazole compound 1-(1,2-dimethylpropyl)-N-ethyl-5-methyl-N-pyridazin-4-yl-pyrazole-4-carboxamide of formula I:

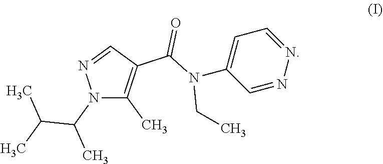 [SMILES: CCN(C(=O)c1cnn(C(C)C(C)C)c1C)c1ccnnc1]

17. The method according to claim 16, wherein the plants are soybean plants.

18. The method according to claim 16, wherein the pests are from the family of Aleyrodidae.

19. The method according to claim 16, wherein the Aleyrodidae pests are Bemisia spp.

20. The method according to claim 16, wherein the pests are Aphis spp., Acrosternum spp., Euschistus spp., Nezara spp. and/or Piezodrus spp.

21. The method according to claim 16, wherein the pests are Pentatomidae, particularly Halyomorpha halys, Megacopta cribraria, and/or Thyanta custator.

22. The method according to claim 16, wherein the pests are from the family of Aphididae, particularly Aphis gossypii, and/or Aphis glycines.

23. The method according to claim 16, wherein the pests are from the family of Cicadellidae (leafhoppers), particularly Amrasca biguttula biguttula, Empoasca fabae, Empoasca Solana, and/or Epoasca kraemeri.

24. The method according to claim 16, wherein the pyrazole compound of formula I is applied in an amount of from 1 to 500 g/ha.

25. The method according to claim 16, wherein the pyrazole compound of formula I is applied by foliar application.

26. The method according to claim 16 for protecting plant propagation material.
